(19) United States
(12) Patent Application Publication
(10) Pub. No.: US 2004/0024823 A1
(43) Pub. Date: Feb. 5, 2004

(54) Email authentication system

(76) Inventor: Michael George Del Monte, New York, NY (US)

Correspondence Address: Michael Del Monte, #16F, 225 W. 83rd Street, New York, NY, 10024, US

(21) Appl. No.: 10/211,913

(22) Filed: Aug. 1, 2002

(51) Int. Cl. G06F 15/16

(52) U.S. Cl. 709/206

(57) ABSTRACT

A method and system for reliably authenticating incoming email is provided, so that only desirable email is delivered to a recipient. The method and system comprise a server that intercepts incoming emails, authenticates them on behalf of the intended recipient, and then either makes them available to the recipient if they are desirable, or discards them if they are not. The invention provides a robust and reliable system for preventing unsolicited emails, commonly known as junk or spam, from reaching end users.

### FIELD OF THE INVENTION

This invention is a method and system that provides the ability to authenticate incoming email reliably so that only desirable email is delivered to a recipient. More particularly, it is a method and system for providing a server that intercepts incoming emails, authenticates them on behalf of the intended recipient, and then either makes them available to the recipient if they are desirable, or discards them if they are not. The invention provides a robust and reliable system for preventing unsolicited emails, commonly known as junk or spam, from reaching end users.

### BACKGROUND OF THE INVENTION

Widespread use of the Simple Mail Transfer Protocol (SMTP; see Network Working Group RFP 821, “Simple Mail Transfer Protocol,” 1982) for email transfer has had the undesirable side effect of allowing unsolicited email, commonly known as junk or spam, to be sent easily and cheaply to recipients who don't want it, and who are largely powerless to prevent it. The problem of spam is well documented; see, e.g., http://spam.abuse.net, a website dedicated to describing the problems of, and potential solutions to, spam. Because one need only have the email address of a recipient in order to send him an email, unsolicited email is difficult to detect and to remove.

Current techniques for reducing or filtering unsolicited emails are either (1) to perform textual filtering on incoming emails (e.g., examining them for telltale signs that they are unsolicited, such as the phrase FREE!!! in the subject line); or (2) to maintain and amass a list of known “spammers”—domains and/or senders who are known to send unsolicited emails—and to reject emails from those domains or senders.

Both of these techniques are easily defeated. Keyword filters are well known to be unreliable. Filters are easily bypassed by a variety of common techniques, including (1) deliberately misspelling key terms and phrases (e.g., “click hear to be removed”); (2) interspersing punctuation or spaces in key terms and phrases (e.g., “G.E.T. O.U.T. O.F. D.E.B.T. N.O.W!”); and (3) sending email in encoded formats such as HTML, and interjecting markup codes into the key words and phrases (e.g., in HTML, “click<!—comment> here <!—comment> for<!—comment> more”), which are not seen by the reader but which defeat most text-scanning filters.

Likewise, blacklists of known spam senders are readily circumvented by spammers who (1) spoof their emails so that the “from” line does not include their actual address; (2) use unwitting “relay” servers from which to send their emails, so that the relay's IP address and not the spammer's own is seen by the receiving server; or (3) employ an ever-shifting array of servers from which to send email.

One technique employed by some users is to create “aliases” for their email address, and to give out those aliases to untrusted parties, reserving their “true” email address only for a close circle of trusted parties (or never giving it out at all). The advantage of using aliases to receive email is that aliases may be canceled, if the user begins to receive spam addressed to a given alias. The user is free to continue receiving email addressed to other aliases, and moreover by keeping track of those to whom he has given his aliases, he can learn (or guess) how a spammer happened to get a particular alias. However, aliases have several disadvantages: (1) Few users have sufficient expertise concerning, or control over, their email system to grant themselves aliases; (2) Aliases are frequently obtuse and difficult for the recipient to use, or remember; (3) Aliases must be always be granted in advance—requiring the user to foresee the need for a new alias, and prepare it prior to giving it out; he cannot produce a new one on the spot, to give out at a meeting or party; (4) Once an alias is compromised (i.e., is obtained by a spammer), canceling the alias cancels the ability for all other senders to use it, which means some legitimate senders may be excluded; (5) When the user sends email to someone, he must remember to use the appropriate alias as his “From” or “Reply-To” address, or the recipient will suddenly have access to the user's “true” email address (or a different alias), either of which compromises his system; (6) If the “true” email address is compromised, aliases are of little use; and (7) Because aliases act just like regular email addresses, they will be bought and sold, encouraging their spread (and eventual compromise).

Other efforts to curb unsolicited email are typically thwarted by the fact that the Internet email system is now so thoroughly entrenched in modern use that alteration of that system (for example, requiring all emails to be “digitally signed” using encryption technology) is useful only for a small subset of users, and fails to accommodate the vast array of public email users and businesses whose mechanism for sending emails has remained largely the same for years. In other words, the entrenched user base of the email system is now so large that a significant modification of the system is unwieldy or impossible.

In modern email systems, the email recipient is typically represented on his mailserver as having an “email account” on that server. In addition to providing him with an email address, the account usually defines properties for incoming (and sometimes outgoing) email for that recipient, such as how much email he may receive, his “inbox” where new email is viewed, and the “from” or “reply-to” address he uses. This system is in such widespread use by complying mail clients (such as Microsoft Outlook and web-based email systems such as Yahoo Mail and Hotmail) that modification of this system would likely be undesirable to the vast majority of email users.

There is thus a need for a method and system to provide the ability reliably to reject unauthenticated email. There is likewise a need for such a system to be implementable without altering the current SMTP protocol, such that it would not require the great mass of users to alter the way in which they use and send email; and to work within the current “email account” metaphor so well understood by modern users. This invention achieves all of these goals.

### SUMMARY OF THE INVENTION

This invention is a method and system for reliably authenticating incoming email so that only desirable email is delivered to a recipient. More particularly, it is a method and system in which a server intercepts incoming emails, authenticates them on behalf of the recipient, and then either makes them available to the recipient, or discards them. The invention is intended to provide a robust, reliable, and easily maintained system for preventing unsolicited emails, commonly known as junk or spam, from reaching end users.

The system and method of this invention comprise an authenticating server which examines incoming emails to determine the email's “from” and “to” addresses. The intended recipient has an “account” with the server, such that emails to him are made available for him to read, typically in an “inbox.” For clarity, we will henceforth refer to the recipient as the “user.” The authenticating server maintains, as part of the user's account, a list of “keyed email addresses” for that user. A keyed email address is associated with a set of rules which specify whether an email having a given “from” address and “to” address will be accepted. (The rules typically list those “from” addresses which are acceptable for sending email to that keyed address.) The incoming email's “to” address is compared against this list of keyed email addresses. Only when the “to” address is found in that list, and when the “from” address meets the rules specified for that “to” address, is the email accepted and made available to the user.

Keyed email addresses thus have the properties that (1) a user may have several of them, all distinct, yet emails addressed to them are all delivered to the same user's account (if they are accepted); and (2) keyed addresses may be used to send mail to the user only by a particular sender or senders, or a particular class of senders. In the preferred embodiment of this invention, keyed email addresses have the further properties that (3) they are easily identified as belonging to the user; (4) they are easily generated by the user; (5) they are easily deleted by the user; and (6) the rules governing their use are easily modified by the user.

In accordance with the objective of this invention, the system and method of this invention further comprise a mechanism accessible to the user for granting and maintaining a set of such keyed email addresses on the server.

In accordance with yet another objective of this invention, the system and method of this invention comprise a mechanism wherein the server can automatically create new keyed email addresses on the user's behalf, in order to facilitate emails arriving from new, presumptively trusted senders; and in order to facilitate sending outbound emails such that the addressee can easily reply to the user.

### BRIEF DESCRIPTION OF THE DRAWINGS

FIG. 1 is a block diagram showing the relationship between computers on a network, which are running the software embodying this invention.

FIG. 2 is a diagram illustrating the sequence of steps carried out by the authenticating server in the preferred embodiment of this invention.

### DESCRIPTION OF THE PREFERRED EMBODIMENT

### I. Overview

The system and method of this invention comprise an authenticating server which examines incoming emails to determine the email's “from” address and its “to” address. The “to” address is compared against a list of “keyed” email addresses maintained by the server. A keyed address has the property that it is paired with a rule set that defines which “from” address or addresses may be used to send email to that “to” address. Only when the email is addressed to a “to” address on that list, for which the “from” address meets the criteria associated with that “to” address, will the email be accepted and made available to the user. (But see the operation of a “default rule,” below.)

In the preferred embodiment of this invention, the authenticating server cooperates with an actual email server, and thus performs only the steps necessary to achieve the objective of this invention. Upon determining that an email is undesirable, it rejects it, and optionally takes steps such as notifying the sender that the email was rejected, and/or notifying the user that the email was rejected. Upon determining that the email is desirable, it passes the email along to the actual email server (using the SMTP system), which then performs the customary steps required to make the email available to the user.

Though keyed email addresses may take any form, in the preferred embodiment of this invention they are composed of both a component common to all keyed addresses for that user (preferably the user's username), and a key part that is unique to each keyed address. Keyed email addresses will also typically contain a domain part, or external addressing component, such as the part of email addresses typically following the @ sign in ordinary Internet email.

The key part of the keyed address is an ordinary string of characters that is acceptable just like an ordinary email address. This string may be an easily remembered, written, typed, and transmitted sort of string, and need not be, by contrast, a confused or “hashed” key consisting of an obtuse or seemingly random string of characters. For ease of use, not only the string but the whole keyed address may appear in plaintext (unencrypted or hashed).

The rules corresponding to a keyed address consist of one or more of the following: (1) accept all email to this address; (2) accept email only from the first N senders who use this address; (3) accept email to this address only from one or more predetermined addresses; (4) accept email to this address only from addresses that meet a characterization test, (for example, addresses that have a certain domain name); or (5) accept no email to this address.

Furthermore, keyed email addresses may expire automatically, or be deleted or invalidated by the user or by an administrator. Moreover, the rules associated with a keyed email address may be modified by the user, or by an administrator.

The set of keyed email addresses and the rules governing their use are easily maintained and modified both by email users and by administrators, through an interface that is mediated by ordinary emails sent to and received from the authenticating server.

The system and method of this invention provide a reliable process for determining when incoming emails are desirable without significantly altering the ordinary process of handling incoming email. The system and method of this invention further provide the significant benefit of allowing a user to cancel or invalidate a keyed email address, or simply change its rules, so that it can no longer be used by particular senders—without preventing desirable senders from reaching the user through that same address.

The invention further provides the significant benefit that a keyed address can only be used by the sender(s) it is given to, and cannot be used by any others, rendering useless the sale or distribution of such addresses to third parties, thereby undermining one of the most common ways in which spammers obtain email addresses.

### II. Components

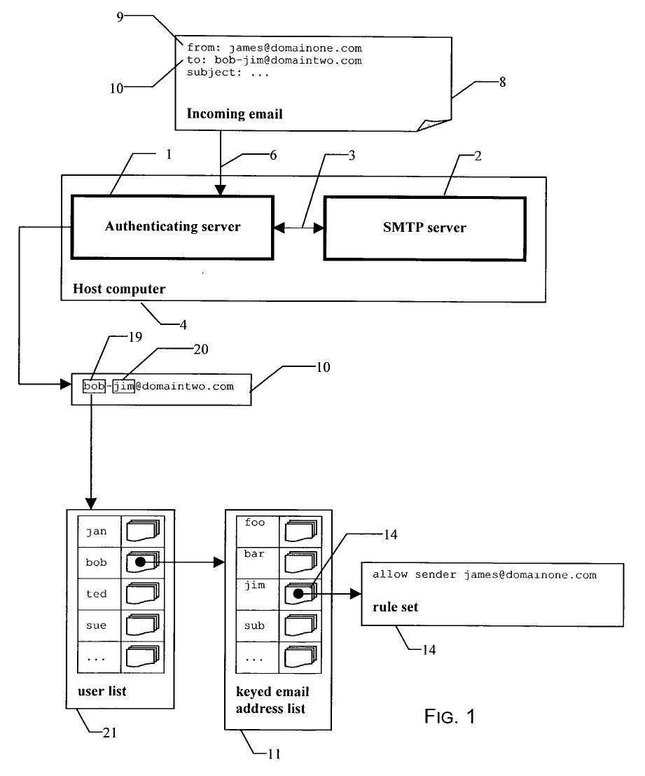

FIG. 1 is a diagram of the elements of the preferred embodiment of this invention, and introduces some of the terms used in the discussion below. An authenticating server 1 is connected to an SMTP server 2 via a local network 3. (The term “local” here is used to indicate only that the authenticating server 1 and the SMTP server 2 cooperate closely, and will likely be closely linked. The network 3 could, in fact, be any sort of network. In the preferred embodiment of this invention, the authenticating server 1 is a piece of software running on a host computer 4 which also runs the SMTP server software 2. In this case the network 3 between them is implemented via software on the host computer 4. In another embodiment, the authenticating server 1 and the SMTP server 2 could comprise a single piece of software, and thus the “network” 3 between them would be implemented through interprocess or intraprocess communication.)

Ordinary SMTP servers commonly “listen” for new connections on port 25, the SMTP port. In the preferred embodiment of this invention, the SMTP server 2 instead listens on a port other than 25, and the authenticating server 1 listens on port 25. The authenticating server 1 then communicates with the SMTP server 2 using ordinary SMTP communications.

The authenticating server 1 receives an email 8 via ordinary SMTP communications over an external network 6. (The term “external” here is used only to distinguish the network 6 from the “local” network 3; in practice, the two networks 3 and 6 could comprise the same physical system.) The authenticating server 1 scans the email 8 to determine its “from” address 9 and the “to” address 10. (The process of determining these addresses is described more fully below.) The authenticating server 1 finds a corresponding rule set 14 by matching the “to” address 10 against a list of keyed email addresses 11.

In the preferred embodiment of this invention, a keyed email address has the property that it is composed of the user's username 19 and a key part 20. The authenticating server 1 first locates the appropriate list 11 by matching the username 19 of the “to” address 10 against a list of users 21. Locating the list 11 is implemented through a case-insensitive binary search of the user list 21 for the username 19, though a variety of equivalent lookup algorithms could be used. In the preferred embodiment of this invention, each keyed email address exists uniquely in the list 11, so that there is at most one matching address and therefore one corresponding set of rules 14 for a given “to” address 10. Locating the rule set 14 is also implemented through a case-insensitive binary search of the list 11 for the key part 20 of the “to” address 10, though again a variety of equivalent lookup algorithms could be used. Moreover, for efficiency the keyed addresses may be represented in the list 11 only by the key part 20 of each address. In FIG. 1, therefore, the keyed addresses are shown as only the key part 20.

In the preferred embodiment of this invention, the authenticating server 1 may in some cases automatically generate a new keyed address and rule set 14 to allow certain emails to be accepted. This will happen in the case where the email's “to” address 10 is “automatically valid.” To avoid digressing at this point, automatically valid addresses are described more fully further below.

If no corresponding rule set 14 is found, a “default” rule may be used in place of the rule set 14. In the preferred embodiment of this invention, the default rule is this: If a list 11 is found but a matching rule set 14 is not, the email 8 is rejected; but if no list 11 is found (indicating that the intended recipient isn't participating in the scheme of this invention), the email 8 is accepted (and the SMTP server 2 will make the final decision as to whether to deliver it).

If the default rule is not used, the authenticating server 1 compares the “from” address 9 against the set of rules 14 to determine whether the “from” address 9 is accepted or rejected by those rules 14. (The types of rules contemplated by this invention are described more fully below.) If the “from” address 9 is accepted by the rules 14, then the authenticating server 1 sends the email 8 to the SMTP server 2, which is then responsible for making the email 8 available for the user. Conversely, if the “from” address 9 is rejected by the rules 14, the authenticating server 1 discards the email 8. The authenticating server 1 may take additional steps, such as sending the email to a “trash” location for later examination; notifying the sender that his email was not delivered; or notifying the user that an email was rejected. In the preferred embodiment of this invention, the authenticating server 1 sends the sender a rejection email notifying him that his email was rejected, and encouraging him to obtain a valid, keyed email address with which to address future email to the user.

### III. Sequence of Communications

The ordinary set of communications in a standard single-recipient SMTP transaction, without the intervention of the preferred embodiment of this invention, is shown in Table 1. A sender (a computer) connects to an SMTP server, whereupon the server sends a server-hello message. The sender replies with its own hello message (“HELO”), to which the server responds with a hello-reply message. The sender then sends a mail-from message, to which the server responds with a sender-ok (or not ok) message. If all is still well, the sender then sends one or more messages specifying the recipients (“RCPT TO”), and the server responds by accepting them (or denying them). Finally, the sender indicates that it is ready to send the body of the email (by saying, “DATA”), to which the server replies with a send-data message. The sender then sends the email contents. The server indicates whether the contents have been received and are ready for delivery, whereupon the sender terminates communications by sending a quit message (“QUIT”), and then the server “hangs up” by disconnecting.

TABLE 1

server: 220 Server ready.
sender: HELO Sender
server: 250 Server, Hello Sender.
sender: MAIL FROM: <james@domainone.com>
server: 250 Sender OK-send RCPTs.
sender: RCPT TO: <bob-jim@domaintwo.com>
server: 250 Recipient OK-send RCPT or DATA.
sender: DATA
server: 354 Please start mail input.
sender: {sends data}
server: 250 Mail queued for delivery.
sender: QUIT
server: 221 Closing connection. Goodbye.

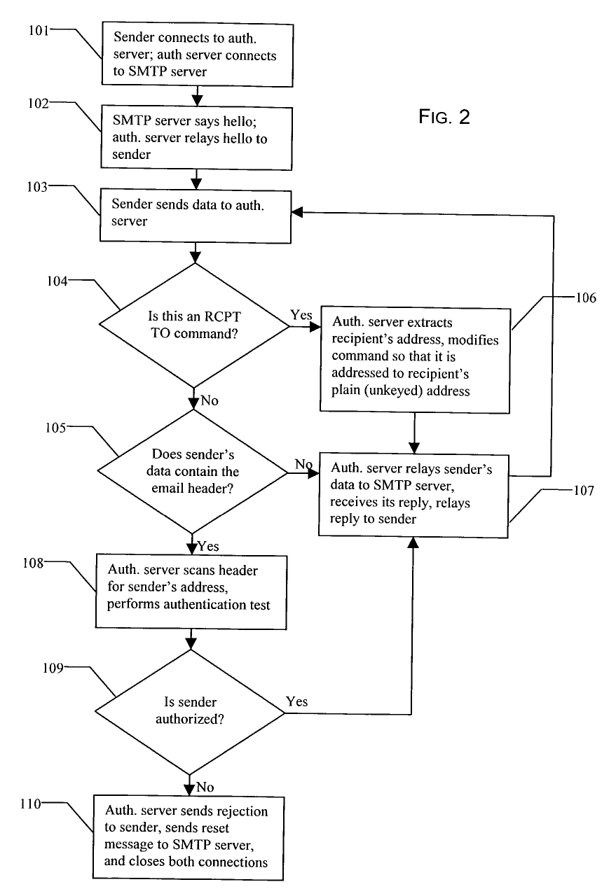

FIG. 2 is a diagram illustrating the sequence of communications in the preferred embodiment of this invention. In step 101, the sender connects to the authenticating server 1, which then connects to the SMTP server 2. (Because the authenticating server 1 is listening for communications on the SMTP port, the sender connects with the authenticating server 1, and not the SMTP server 2, which is listening on a different port.) In the next step 102, the SMTP server 2 sends its hello message, which the authenticating server 1 relays to the sender.

Beginning with step 103, the authenticating server 1 enters a relaying loop. In this loop, the authenticating server 1 receives data from the sender in step 103, examines it in steps 104 and 105, and passes it on to the SMTP server 2 in step 107. In step 107, the authenticating server 1 also receives the SMTP server's 2 response, and relays it to the sender.

All data is passed on to the sender or the SMTP server 2 unchanged, with two exceptions. First, when the authenticating server 1 receives an RCPT TO message, it extracts from the message the “to” address 10, and derives its corresponding username 19 and the key part 20. It also changes the message so that it is addressed to the user's plain (unkeyed) email address, as shown in step 106. The unkeyed address is any address that the SMTP server 2 will use to deliver mail for that user. In practice, this is likely to be just the username 19 part of the address 10, together with any domain part. For example, an email addressed to “bob-jim@domaintwo.com” would be changed to “bob@domaintwo.com”. This enables the SMTP server 2 to complete the delivery to the user, without needing anything more than the user's “ordinary” (unkeyed) address—that is, if the communication is completed successfully and the authenticating server 1 does not reject the email 8, of course.

Second, when the authenticating server 1 has received the email's “header,” it scans it to identify the “from” address 9 (this identification process is described more fully below), in step 108. It then performs an authentication procedure, shown in step 109 (described more fully above). The authentication procedure of step 109 determines whether the email 8 shall be accepted or rejected. If the email 8 is to be rejected, in step 110 the authenticating server 1 sends a rejection message (e.g., “553 Requested action not taken”) to the sender. Contemporaneously, it sends a reset message (“RSET”) and then a quit message (“QUIT”) to the SMTP server 2 (causing it to abort the current transaction), and closes both connections. If, on the other hand, the email 8 is to be accepted, the authenticating server 1 merely continues relaying data between the sender and the STMP server 2, as before.

### IV. Identifying the Sender's Email Address

In an standard SMTP transaction, the “mail-from” message often does not specify the “from” address 9. Instead, it will commonly specify a “reverse path” which indicates the email's routing. The “from” address 9 must therefore be extracted from the header of the email contents, which according to current practice immediately precedes the email body, and is separated from it by a double pair of carriage return/line-feed symbols.

The header lists a number of fields, each listed on a separate line and preceded by an identifier (such as “Subject” or “Cc”). The appropriate “from” address 9 is found on a line following an identifier such as “Reply-To,” “From,” or “Return-Path.”

In order to facilitate sending email to a user from multiple locations, the authenticating server 1 will seek for a rule set 14 which would accept any of these “from” addresses, even though the other “from” addresses could be rejected. In this way, a sender who is acceptable when he sends email from, say, “james@domainone.com” to “bob-jim@domaintwo.com,” can be sure that his email will be delivered even if he sends from another location, by specifying “james@domainone.com” as one of his From, Reply-To, or Return-Path addresses.

Furthermore, the authenticating server 1 may also automatically change the allowed “from” address for the matching rule set 14, if it sees within the body of the email a line (not necessarily in the header) such as “Old-Address: <address>.” In this way, senders can automatically both authenticate their email, and update the address from which they will be allowed to send, without the user's intervention. (For simplicity, this extra step is omitted from FIG. 3.) However, as this capability may undermine the property that keyed addresses are not freely transferable, it is likely that this feature will commonly be disabled, for some or all keyed addresses.

### V. Rules

The rules for a particular keyed email address, in the preferred embodiment of this invention, may be one of the following: (1) accept all email to this address; (2) accept email only from the first N senders who send to this address; (3) accept email to this address only from one or more predetermined “from” addresses 9; (4) accept email to this address only from those “from” addresses 9 that meet a characterization test; or (5) accept no email to this address.

The characterization test asks simply whether the “from” address 9 has a particular Internet domain name. In this way, a keyed email address may be made available for use by anyone sending from a particular domain, such as someone sending from within a company.

In the preferred embodiment of this invention, the rules, or the keyed email addresses to which they are attached, may be set to expire after a certain time, or after a certain number of uses.

### VI. Keyed Email Addresses

A keyed email address for a user in this invention is an address that may be paired by the authenticating server 1 with a rule set 14, to govern whether a particular “from” address 9 may be used to send email to that user. As described above, in the preferred embodiment of this invention a keyed email address is composed of the user's username 19 and a key part 20.

The user may select the key part 20 for a particular keyed address, and the key part 20 may be any ordinary string of characters that is usable within the normal SMTP mail system. For example, the user might choose the word “family” for the key part 20 of a keyed address that will be made available to family members. In the preferred embodiment of this invention, the username 19 and the key part 20 are separated by a delimiter character, such as a hyphen, so that the username 19 and key part 20 are easily distinguished and separated. (However, any other technique may be used to compose the address of the username 19 and key part 20, including hashing the two together, or creating any other composition. In fact it is unnecessary that the keyed email address be composed of a username 19 and/or key part 20 at all—the keyed address can be anything at all, so long as it can be associated by the authenticating server 1 with a rule set 14, as described above. However, a concatenated, plaintext username 19 and key part 20 is desirable because it is more easily written, typed, and remembered by people.)

In addition, other keyed addresses may be created automatically by the authenticating server 1, as described below.

### VII. Administration

In the preferred embodiment of this invention, the user's list of keyed email addresses 11 may be administered and maintained by the user himself. Particularly, the user may add, modify, and delete entries in his list 11 by sending ordinary emails to the authenticating server 1, containing one or more commands to add, modify, or delete entries in his list 11. It is anticipated that in one embodiment of this invention, such emails may be easily generated by other software made available to the user for that purpose; or as easily through simple modifications to his favorite email program, such as Microsoft Outlook.

In ordinary use, the user will create a new keyed email address and rule set for the purpose of giving the keyed address to a particular sender. (The form of keyed addresses in this invention lends itself to easy construction, so that the user can make up a new keyed address on the spot—for example, at a meeting—and need not arm himself with pre-generated keys for the occasion.) Commonly, the new keyed address will be assigned a rule set 14 that says it is useable only by the first “from” address 9 to send email to that keyed address. The user adds that keyed address with its associated rule set 14 to his list of keyed addresses 11 by communicating it to the authenticating server 1. He may do so at any time, but of course he should add it before the sender attempts to send email to it.

The authenticating server 1 may also automatically create a new keyed email address and rule set 14 upon receipt of an email to an “automatically valid” address. An automatically valid address is one which the authenticating server 1 can identify as being valid for use, even though it does not yet exist in the list of keyed addresses 11. In the preferred embodiment of this invention, the user is granted one or more passwords which define a range of automatically valid addresses, of the form “username-passwordXX@domain.com,” where XX is any pair of digits. The user may freely give out new automatically valid addresses of this form, without having to add the address to his list of keyed addresses 11 in advance.

As before, the user is easily able to change his password(s) with the authenticating server 1, through the same interface(s) described above. Moreover, the user may assign the rule set 14 to be associated with new automatically valid addresses created by the authenticating server 1, so that, for example, all new automatically valid addresses having a particular password will be assigned the rule, “valid for first ‘from’ address only.”

Because automatically valid addresses of the form described above may be guessed by an undesirable sender (if such a sender has obtained one address of the class), it should be understood that automatically valid addresses are somewhat less secure than other keyed addresses, and should be used with greater care. However, because the user retains the ability to delete the address, to change its rule set 14, or to change the password, the amount of undesirable mail he might receive at these addresses remains entirely under his control.

Keyed addresses may also be created automatically by the authenticating server 1, when the user sends outbound email. When the authenticating server 1 receives an outbound email from a user, the server 1 can check the keyed address list 11 for that user to determine whether there exists a keyed email address with a rule set 14 which would allow the recipient to send email back to the user. (For example, when “bob@domaintwo.com” sends an email to “james@domainone.com,” the authenticating server 1 would examine the list 11 for user “bob” and see that the recipient (“james@domaineone.com”) can send email to bob via the keyed address “bob-jim@domaintwo.com.”) If no such keyed address is found, then the authenticating server 1 may construct a new keyed email address especially for that recipient. The authenticating server 1 then modifies the outbound email so that its “reply-to” address is given as the appropriate keyed email address. In this way, the user can freely send email to a new recipient, without the trouble of creating, in advance, a keyed email address for her to use in reply. Moreover, because the authenticating server 1 can automatically modify the email to specify the correct “reply-to” address for the recipient, the user is spared the difficulty of himself specifying the correct reply-to address each time he sends email. The recipient then just needs to reply to the email as she normally would; her email client program will address the reply to the correct keyed email address, and she can be certain that it will be accepted and received.

The ability of the authenticating server 1 to create an automatic keyed address for the purpose of enabling the recipient to reply may be used in novel ways. For example, a user could create a “single reply” email, limiting the recipient to one response. Single-reply emails may be useful in maintaining control of a dialogue with a new party, in which the user seeks only a limited exchange and, once satisfied, will desire no further contact from that party. A single-reply email would be generated by creating a keyed email address which automatically expires upon its first use, and changing the outbound email so that it uses that keyed address as its “reply-to” address.

This invention may be embodied in other specific forms without departing from its spirit or essential characteristics. The described embodiments are to be considered in all respects only as illustrative and not restrictive. The scope of the invention is therefore indicated by the appended claims rather than by the foregoing description. All changes which come within the meaning and range of equivalency of the claims are to be embraced within that scope.

I claim:

1. A computer-based system for preventing the transmission of an email to a user, comprising:
an authenticating server which receives said email from a sender, wherein said server associates a list of two or more keyed addresses with said user, and wherein said email has a “from” address and a “to” address;
a means for determining a subset of said list of keyed addresses which match said “to” address;
a set of rules defining whether said “from” address is acceptable for sending email addressed to any of said subset of matching keyed addresses; and
a means for rejecting said email based on said set of rules.

2. The system of claim 1, wherein at least two of said keyed addresses are partly composed of a component common to both said composed keyed addresses.

3. The system of claim 2, wherein said common component is sufficient to allow said server to identify said user.

4. The system of claim 3, wherein said server associates a username with said user, and wherein said common component is said username.

5. The system of claim 4, wherein said common component is said username in plain text.

6. The system of claim 2, wherein at least one said composed keyed address is also partly composed of a key part component, wherein said key part component is in plain text.

7. The system of claim 6, wherein said composed keyed address is easily remembered, written, transmitted, and typed by ordinary, unaided humans.

8. The system of claim 6, wherein said composed keyed address contains said common component in plain text, concatenated to a delimiting string of one or more characters, concatenated to said key part component in plain text.

9. The system of claim 1, wherein the cancellation or modification of any one said keyed address does not affect whether said system will reject other emails addressed to others of said keyed addresses.

10. The system of claim 1, wherein the cancellation or modification of any one said rule does not affect whether said system will reject other emails based on other said rules.

11. The system of claim 1, wherein one or more of said keyed email addresses can be used as Internet email addresses with the SMTP protocol.

12. The system of claim 1, wherein said server receives said email using the SMTP protocol.

13. The system of claim 1, wherein said user can create new said keyed addresses.

14. The system of claim 1, wherein said user can create, modify, and delete said keyed addresses.

15. The system of claim 1, wherein said user can create new said keyed addresses by communicating with said server using the SMTP protocol.

16. The system of claim 1, additionally comprising a means for determining whether said “to” address is automatically valid, and wherein said server may add a new keyed address to said list if said “to” address is automatically valid, such that said “to” address would match said new keyed address.

17. The system of claim 16, wherein said server may associate a password with said user, such that any said automatically valid addresses contain such password in plain text.

18. The system of claim 17, wherein said automatically valid addresses additionally contain a string of digits.

19. The system of claim 1, wherein said server also may receive an outbound email from said user.

20. The system of claim 19, wherein said server may change said outbound email to use a keyed address as the reply address for said outbound email.

21. The system of claim 19, wherein said server may add a new keyed address to said list, and change said outbound email to use said new keyed address as the reply address for said outbound email.

22. The system of claim 1, wherein said keyed addresses may expire.

23. The system of claim 1, wherein said rules may expire.

24. The system of claim 1, wherein said authenticating server cooperates with an SMTP server, wherein said SMTP server delivers said email to said user, if said email is not rejected.

25. The system of claim 1, wherein said user has an “inbox,” and wherein all emails received by said server are made available to said user through said inbox, if said emails are not rejected.

26. The system of claim 1, wherein said server may automatically notify said sender if said email was rejected.

27. A method for preventing the transmission of an email to a user, wherein said email has a “from” address and a “to” address, comprising the steps of:
maintaining a list of at least two keyed addresses for said user, wherein each said keyed address is associated with a set of rules defining which “from” addresses are acceptable for sending email to said keyed address;
matching said “to” address against said list of keyed addresses; and
rejecting said email if said “from” address is not acceptable for sending email to said “to” address.

28. The method of claim 27, wherein at least two of said keyed addresses are partly composed of a component common to both said composed keyed addresses.

29. The method of claim 28, wherein said common component is said username in plain text.

30. The method of claim 29, wherein at least one said composed keyed address is also partly composed of a key part component, wherein said key part component is in plain text.

31. The method of claim 30, wherein said composed keyed address is easily remembered, written, transmitted, and typed by ordinary, unaided humans.

32. The method of claim 31, wherein said composed keyed address contains said common component in plain text, concatenated to a delimiting string of one or more characters, concatenated to said key part component in plain text.

33. The method of claim 30, comprising the additional step of determining whether said “to” address is automatically valid, wherein said “from” address is acceptable for sending email to said “to” address even though no other said rules specify that said “from” address is acceptable for sending email to said “to” address.

34. A computer-based system for transmitting an email, having a “to” address and a “from” address, to a user, comprising:
a server which receives said email;
a username which said server associates with said user;
a list of two or more keyed addresses which said server associates with said user, wherein each said keyed address begins with said username, followed by a delimiting character, followed by a key part unique to each of said keyed addresses; and
a set of rules which specify whether said “from” address is acceptable for sending email addressed to any of said keyed addresses;
wherein said server transmits said email only if said rules specify that said “from” address is acceptable for sending said email to said “to” address.
